(19) United States
(12) Patent Application Publication
(10) Pub. No.: US 2018/0271284 A1
(43) Pub. Date: Sep. 27, 2018

(54) OVERTURN PREVENTING DEVICE

(71) Applicant: KYB CORPORATION, Minato-ku, Tokyo (JP)

(72) Inventors: Yukiko ISHIHARA, Minato-ku, Tokyo (JP); Shinichi SEKINE, Minato-ku, Tokyo (JP); Eishin NOGUCHI, Minato-ku, Tokyo (JP)

(73) Assignee: KYB CORPORATION, Minato-ku, Tokyo (JP)

(21) Appl. No.: 15/764,510

(22) PCT Filed: Aug. 16, 2016
(86) PCT No.: PCT/JP2016/073937

§ 371 Date: Mar. 29, 2018

(30) Foreign Application Priority Data
Jan. 26, 2016 (JP) 2016-012397

(51) Int. Cl. A47B 97/00; F16F 3/04; F16F 1/06; F16F 15/067

(52) U.S. Cl. CPC A47B 97/00; F16F 3/04; F16F 1/06; F16F 15/067; F16F 2234/02; F16F 2224/0208; F16F 2230/16; F16F 2232/08; A47B 2097/008

(57) ABSTRACT

Providing an overturn preventing device which has can successfully prevent an article from overturn with a simple structure. A damper of the overturn preventing device has a cylinder, a rod, and a spring. The cylinder is mounted between a top surface of a piece of furniture installed on an installation surface and a ceiling so that a direction of extension/contraction makes a predetermined angle relative to a vertical direction. The cylinder has two ends one of which is open to be formed into an opening and the other of which is closed to be formed into a bottom. The rod is inserted into the cylinder and has a distal end protruding from the opening. The spring is provided between a proximal end of the rod and the bottom of the cylinder. Two bases are rotatably coupled to the bottom of the cylinder and the distal end of the rod, respectively, and the bases abut against the top surface of the furniture and the ceiling, respectively.

### TECHNICAL FIELD

The present invention relates to an overturn preventing device.

### BACKGROUND ART

Patent Document 1 discloses a conventional overturn preventing device. This overturn preventing device includes an article-side base, a ceiling-side base, a damper, and a biasing unit. The article-side base is contactable with an article. The ceiling-side base is contactable with a ceiling. The damper has two ends respectively coupled to the article-side and ceiling-side bases so that the damper is rotatable. The damper includes a cylinder, a piston, and a rod. The cylinder is filled with hydraulic fluid. The piston is slidably inserted into the cylinder, dividing an interior of the cylinder into a rod-side pressure chamber and a counter rod-side pressure chamber. The rod has two ends one of which is coupled to the piston and the other of which protrudes out of the cylinder. The damper is extended/contracted with shake of the article to cause the hydraulic fluid to come and go through an orifice provided in the piston between the rod-side pressure chamber and the counter rod-side chamber, thereby generating a damping force. The biasing unit comprises a nitrogen gas filling the cylinder to bias the damper in an extension/contraction direction.

When to be installed between the article and the ceiling, the overturn preventing device is inserted between the article and the ceiling with the damper being contracted against the biasing force of the biasing unit. And then, the damper is extended between the article and the ceiling by the nitrogen gas serving as the biasing unit so that the article-side base is brought into surface contact with the article and so that the ceiling-side base is brought into surface contact with the ceiling. The damper is biased in the extension direction by an expansion force of the nitrogen gas. As a result, the overturn preventing device is biased in a direction such that the article-side and ceiling-side bases depart from each other, so that the bases are respectively pressed against the article and the ceiling. Thus, the overturn preventing device can be mounted between the article and the ceiling.

The damper is rotatably coupled to the article-side and ceiling-side bases in this overturn preventing device. As a result, upon shake of the article, the article-side base and the damper can fellow the movement of the article. When the dimension between a top surface of the article and the ceiling changes with shake of the article, the damper is extended/contracted in response to the change in the dimension between the top surface of the article and the ceiling, thereby generating a damping force. Consequently, the overturn preventing device can successfully suppress the shake of the article and prevent the article from overturn without falling from between the article and the ceiling and without damaging the article and the ceiling.

### PRIOR ART DOCUMENT

### Patent Documents

Patent Document 1: Japanese Patent Application Publication No. JP 2015-6330

### SUMMARY OF THE INVENTION

### Problem to be Overcome by the Invention

However, the overturn preventing device of Patent Document 1 uses the hydraulic fluid to generate the damping force. Furthermore, the cylinder is filled with the nitrogen gas in order to bias the damper in the extension direction. Accordingly, there is a possibility that the structure of the overturn preventing device would be complicated in order to prevent the hydraulic fluid and the nitrogen gas from leaking outside. Furthermore, since the hydraulic fluid and the nitrogen gas need to be treated in the manufacture of the overturn preventing devices, there is also a possibility that manufacture facilities would be complicated.

The present invention was made in view of the above-described circumstances in the conventional art and has an object to provide an overturn preventing device can successfully prevent the article from overturn with a simple structure.

### Means for Overcoming the Problem

An overturn preventing device of the present invention includes a damper and a pair of bases. The damper has a cylinder, a rod, and a spring. The cylinder is mounted between a top surface of an article installed on an installation surface and a ceiling so that a direction of extension/contraction makes a predetermined angle relative to a vertical direction. The cylinder has two ends one of which is open to be formed into an open end and the other of which is closed to be formed into a closed end. In other words, the cylinder is bottomed. The rod is inserted into the cylinder and has a distal end protruding from the open end of the cylinder. The spring is provided between a proximal end of the rod and the closed end of the cylinder. The paired bases are rotatably coupled to the closed end of the cylinder and the distal end of the rod, respectively, and the bases abut against the top surface of the article and the ceiling, respectively.

The spring of the overturn preventing device of the invention may have a plurality of different spring constants with respect to the direction of extension/contraction.

The spring of the overturn preventing device of the invention may include a plurality of spring members having different spring constants and arranged in series with each other.

The spring of the overturn preventing device may include a plurality of spring members having different spring constants and arranged in parallel with each other.

The paired bases of the overturn preventing device may be swung in a direction intersecting a rotation direction relative to the rod.

The article includes furniture, book shelves, refrigerators, showcases, server racks, a bed having a plurality of beds connected to each other in the up-down direction, and large sized televisions, and the like all of which have a possibility of being overturned by shaking of earthquake or the like.

### BRIEF DESCRIPTION OF THE DRAWINGS

FIG. 1 is a side view of the overturn preventing device of a first embodiment, mounted between a top surface of furniture and the ceiling;

FIG. 2 is a front view of the overturn preventing device of the first embodiment, mounted between the top surface of the furniture and the ceiling;

FIG. 3 is a partial cross section of a damper and a first base of the overturn preventing device of the first embodiment;

FIG. 4 is a perspective view of the damper, the first base, and a fall preventing part of the overturn preventing device of the first embodiment;

FIG. 5 is a partial cross section of the damper, the first base, and the fall preventing part in the first embodiment;

FIG. 6 is a partial cross section of the damper, the first base, and an angle regulator of the overturn preventing device of the first embodiment;

FIG. 7 is a cross section of the damper in the first embodiment;

FIG. 8 is a cross section of the damper in a second embodiment;

FIG. 9 is a cross section of the damper in a third embodiment; and

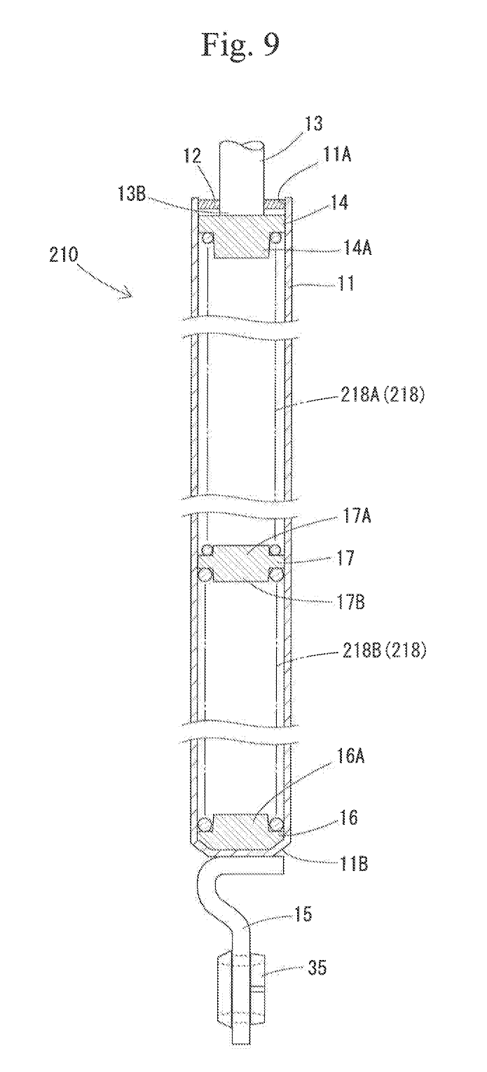

FIG. 10 is a cross section of the damper in a fourth embodiment.

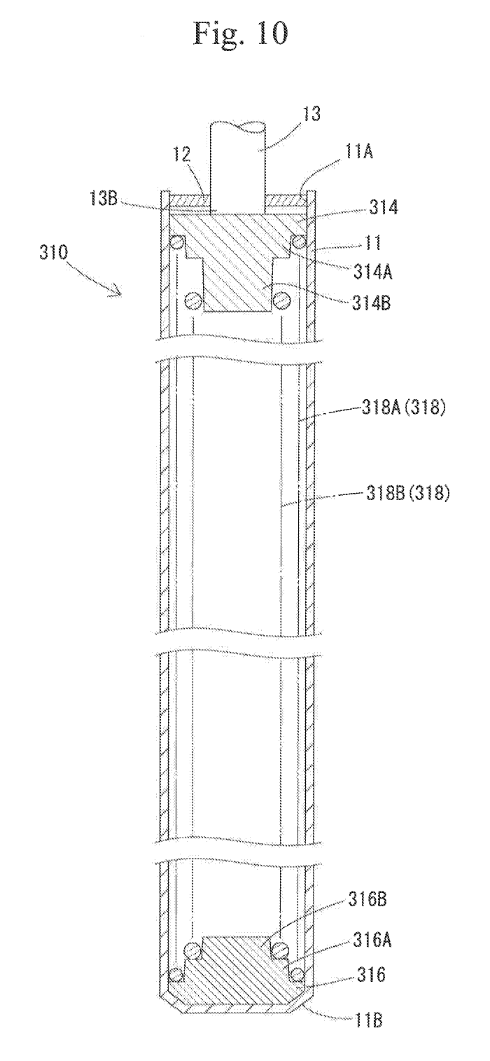

### BEST MODE FOR CARRYING OUT THE INVENTION

First to fourth embodiments of the overturn preventing device of the present invention will be described with reference to the drawings.

### First Embodiment

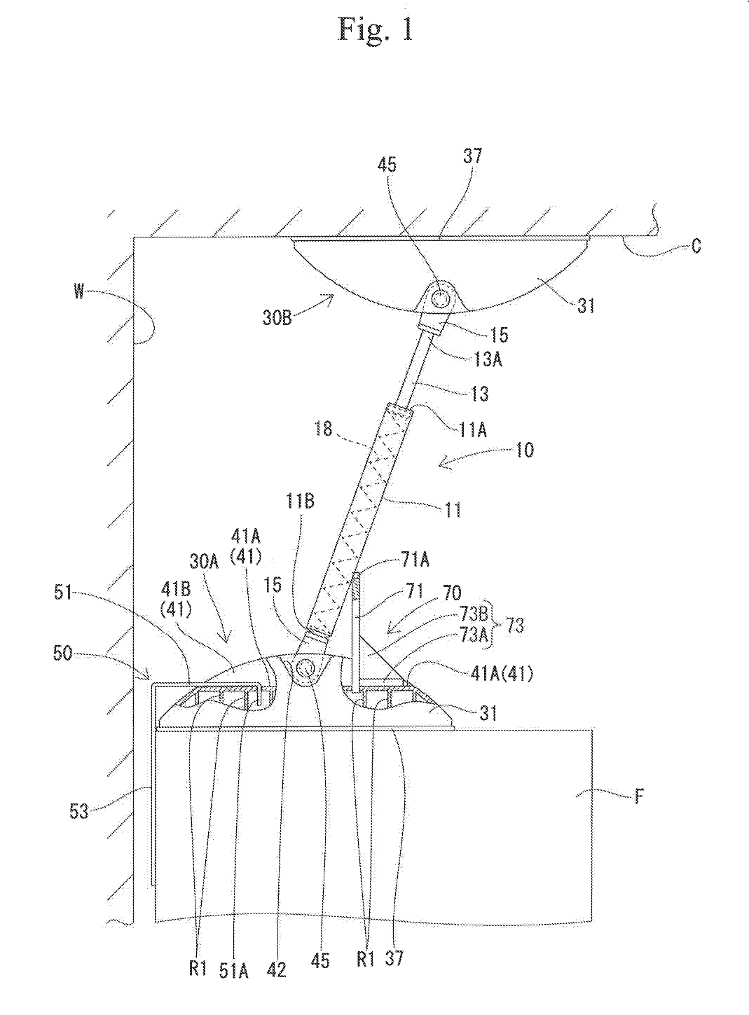

At least one overturn preventing device of the first embodiment is mounted between a top surface of a piece of furniture F and a ceiling C, as illustrated in FIG. 1. The furniture F is installed on a floor surface (not illustrated) while a rear surface of the furniture F is opposed to a wall surface W extending in a vertical direction from the floor surface. The furniture F is formed into a rectangular parallelepiped shape and has a door, drawers (neither illustrated) and the like in a front surface (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device is not mounted on the furniture F, the furniture F would possibly be tilted frontward (rightward in FIG. 1) by shaking of earthquake or the like thereby to be overturned.

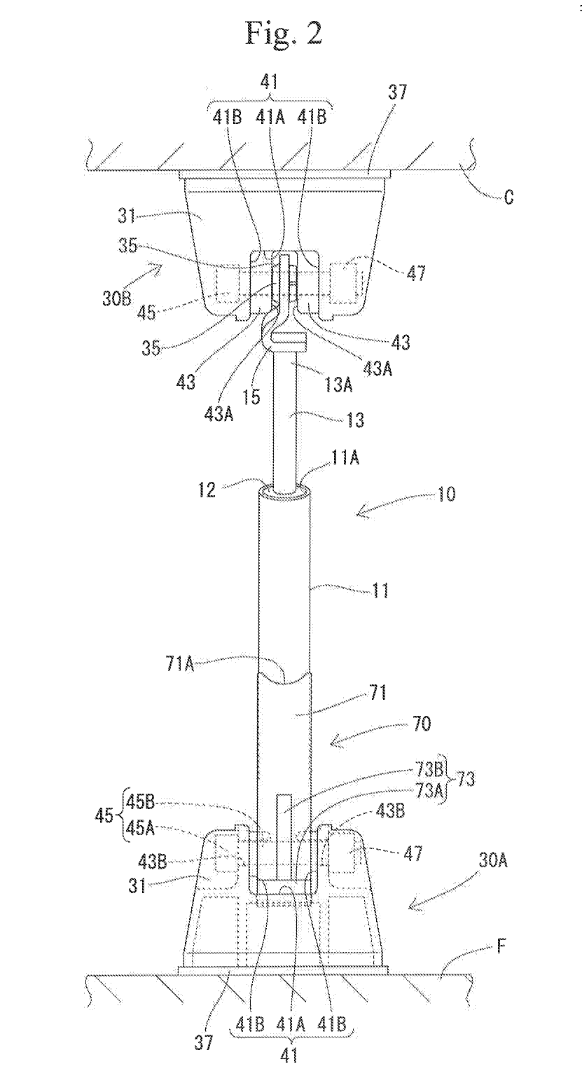

The overturn preventing device includes a damper 10, a pair of bases 30A and 30B, a fall preventing part 50, and an angle regulator 70, as illustrated in FIGS. 1 and 2.

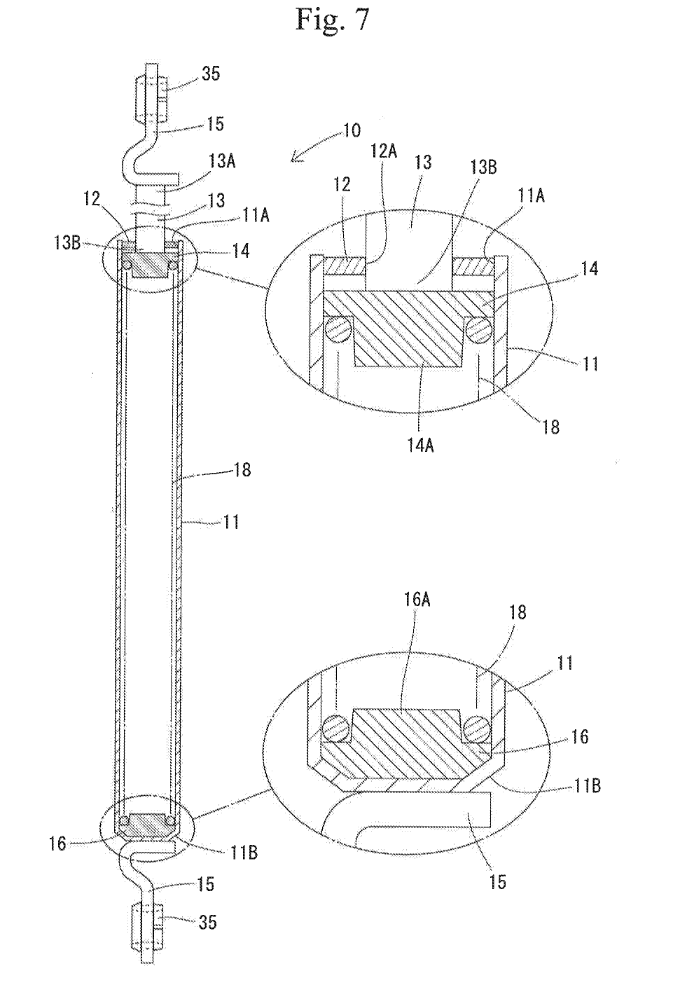

The damper 10 has a cylinder 11, a rod guide 12, a piston 14, a rod 13, an abutting member 16, a spring 18, and two joints 15, as illustrated in FIG. 7. The cylinder 11 is cylindrical in shape and extends in one direction. The cylinder 11 has two ends one of which is open to be formed into an opening 11A serving as an open end and the other of which is closed to be formed into a bottom 11B serving as a closed end. In other words, the cylinder 11 is bottomed. The rod guide 12 is formed into a flat plate shape and closes the opening 11A of the cylinder 11. The rod guide 12 is provided with a first insertion hole 12A extending therethrough in a thickness direction.

The piston 14 is slidably inserted into the cylinder 11. The piston 14 is provided with a first guide 14A which is formed to protrude from a central part of one end surface thereof. The first guide 14A has an outer diameter that is slightly smaller than an inner diameter of the spring 18 which will be described later. The rod 13 has a proximal end 13B coupled to the other end surface of the piston 14. The rod 13 is inserted through the first insertion hole 12A of the rod guide 12, so that the distal end 13A side thereof protrudes out of the cylinder 11. In other words, the rod 13 is inserted through the cylinder 11 with the distal end 13A protruding from the opening 11A.

The abutting member 16 is provided in the bottom 11B that is a closed end in the cylinder 11. The abutting member 16 is provided with a second guide 16A which is formed to protrude from a central part of one end surface thereof. The second guide 16A has an outer diameter that is slightly smaller than the inner diameter of the spring 13 which will be described later. The abutting member 16 has the other end abutting against the bottom 11B in the cylinder 11.

The spring 18 is a compression coil spring formed of a metal wire that is a wire material into a helical shape. The spring 18 is inserted in the cylinder 11. The spring 18 has an outer diameter of the helical shape that is slightly smaller than an inner diameter of the cylinder 11. In the spring 18, from one end to the other end thereof in the extension/contraction direction, the outer diameter of the helical shape is constant and a dimension between parts adjacent to each other in the extension/contraction direction, of the helically formed metal wire is, also constant. The spring 18 has two ends one of which abuts against an end surface of the piston 14. The first guide 14A of the piston 14 is inserted into one end part of the spring 18. The other end of the spring 18 abuts against the one end surface of the abutting member 16. The second guide 16A of the abutting member 16 is inserted into the other end part of the spring 18. In other words, the spring 18 is provided between the proximal end 13B of the rod 13 and the bottom 11B of the cylinder 11.

Each joint 15 is formed by bending a flat plate-shaped metal fitting (see FIGS. 1 to 3). The joints 15 are respectively connected to the bottom 11B of the cylinder 11 and the distal end 13A of the rod 13 (see FIGS. 1 and 2). Each joint 15 is formed with a through hole 15A extending therethrough in a direction perpendicular to an axis line of the damper 10 (see FIGS. 1 to 3).

In the damper 10 thus formed, when the rod 13 is pushed into the cylinder 11 so that the spring 18 is compressed, an elastic force is generated in a direction such that the rod 13 extends from the cylinder 11. The elastic force becomes larger as the dimension of a part of the rod 13 pushed into the cylinder 11 is increased. Furthermore, the magnitude of the elastic force generated when the spring 18 is compressed by a unit length depends upon a spring constant. The spring constant represents the magnitude of elastic force generated by the spring in a direction opposed to the direction of compression/extension when the spring is compressed/extended by a unit length. For example, when the spring is compressed or extended by a predetermined dimension, a spring with a larger spring constant generates a larger elastic force than a spring with a smaller spring constant. The spring constant is proportionate to a cross-sectional area of metal wire forming the spring, a dimension between parts adjacent to each other in the extension/contraction direction, of the helically formed metal wire, and the like, the spring contact is inversely proportional to the outer diameter of the spring.

The paired bases 30A and 30B are respectively a first base 30A to which the joint 15 connected to the bottom of the cylinder 11 is coupled and a second base 30B to which the joint 15 connected to a distal end of the rod 13 is coupled, as illustrated in FIGS. 1 and 2. The first base 30A is placed in abutment on the top surface of the furniture F, and the second base 30B abuts against the ceiling. The first and second bases 30A and 30B have the same form and the same structure. Each of the bases 30A and 30B has a base body 31, a bolt 45 and a nut 47 serving as a rotating shaft member, a bush 35, and a slip preventing part 37, as illustrated in FIGS. 1 to 4.

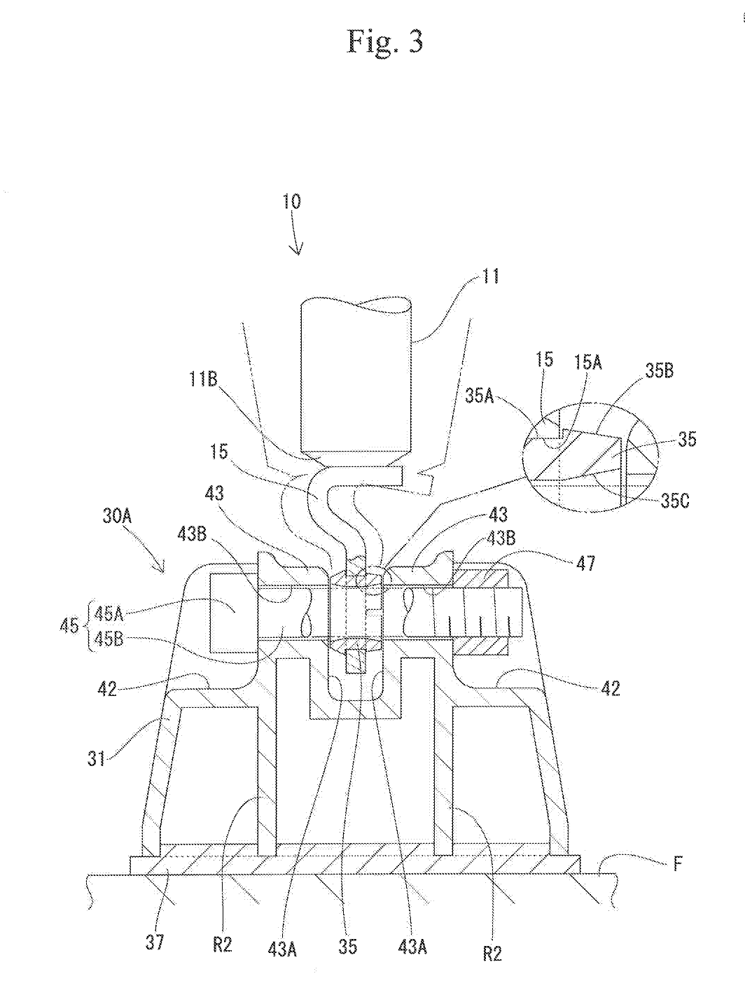

The base body 31 has a rectangular shape in a planar view as viewed from above in a state where the first base 30A is placed in abutment on the top surface of the furniture F (hereinafter, a direction in which a long side in the outer shape of the base body 31 extends in this planar view will be referred to as “a long side direction” and a direction in which a short side extends will be referred to as “a short side direction”). Furthermore, in a side view of the first base 30A as viewed in the short side direction in the state where the first base 30A is placed in abutment on the top surface of the furniture F, the base body 31 has a lower edge which extends straightforward in parallel to the top surface of the furniture F and an upper edge which upwardly bulges from both sides of the lower edge thereby to have an arc shape (refer to FIG. 1). Still furthermore, in a side view of the first base 30A as viewed in the long side direction in the state where the first base 30A is placed in abutment on the top surface of the furniture F, the base body 31 has a trapezoidal shape in which the upper edge is shorter than the lower edge (refer to FIGS. 2 and 3).

In the first base 30A placed in abutment on the top surface of the furniture F, the base body 31 has a groove 41 which is formed in an upper surface thereof and extends in the long side direction (a right-left direction as viewed in FIG. 1 and a depthwise direction as viewed in FIGS. 2 and 3). The groove 41 has a bottom 41A spreading on a horizontal surface and inner wall surfaces 41B respectively rising from both sides of the bottom 41A substantially in a vertical direction. The bottom 41A of the groove 41 extends substantially at a middle of the base body 31 in the up-down direction. Furthermore, the bottom 41A of the groove 41 has a constant width except for a portion formed with a pair of convex portions 43 which will be described later.

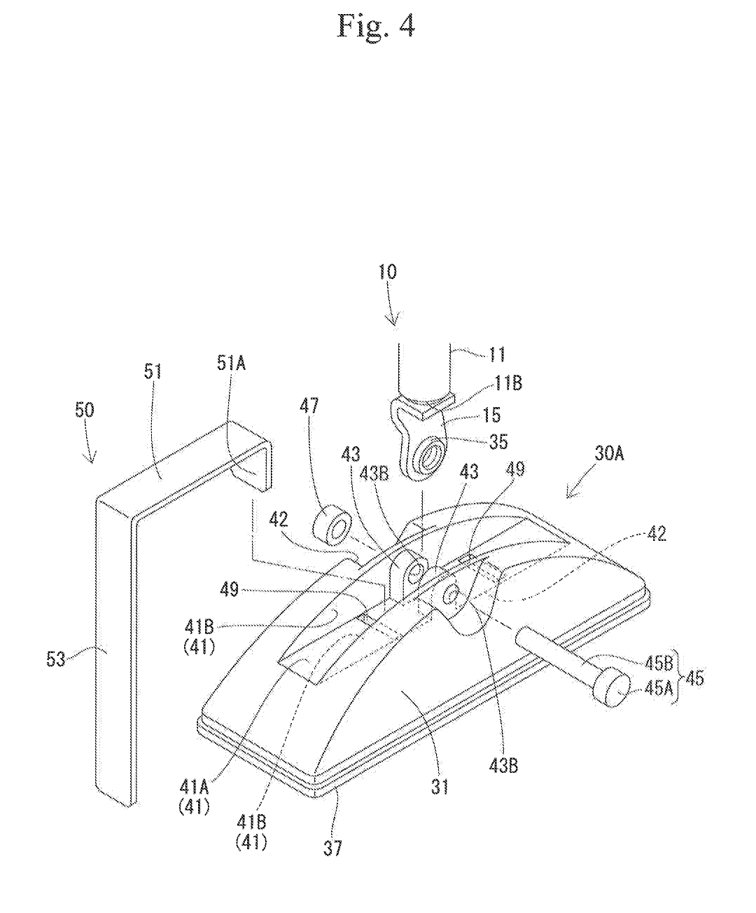

The groove 41 has the paired convex portions 43 which are formed at a central part thereof in the long side direction to protrude from the bottom 41A and both inner wall surfaces 41B of the groove 41, as illustrated in FIG. 4. A space is defined between the convex portions 43 as illustrated in FIGS. 2 and 3. The joint 15 of the damper 10 and a bush 35 which will be described later are fitted into the space. The space communicates with the groove 41. A distance (a dimension of the space in the short side direction) between the respective inner wall surfaces 43A of the convex portions 43 is slightly longer than a length of the bush 35. Furthermore, the convex portions 43 are respectively provided with second insertion holes 43B which are formed to extend through upper central parts thereof in the short side direction and through which a shaft part 45B of the bolt 45, which will be described later, is inserted.

A pair of locked holes 49 having the same configuration is formed in the bottom 41A of the groove 41. The locked holes 49 are formed so that respective distances from the convex portions 43 toward both ends of the groove 41 are substantially equal to each other. Each locked hole 49 has the shape of a slit extending over an entire width of the groove 41. In other words, each locked hole 49 has a length equal to the width of the groove 41 and a width that is slightly larger than a thickness of a locking part 51A of the fall preventing part 50 and a thickness of an insertion part 71B provided in the angle regulator 70 which will be described later. One of the locked holes 49 serves as a locked part into which the locking part 51A of the fall preventing part 50 is inserted thereby to be locked. The other locked hole 49 serves as a locked part into which the insertion part 71B provided in the angle regulator 70 is inserted thereby to be locked.

In the first base 30A placed in abutment on the top surface of the furniture F, the base body 31 has recesses 42 respectively formed in both sides of the groove 41 in the middle in the long side direction. The recesses 42 are each open upward and outward with respect to the snort side direction. The recesses 42 each have a side in which the second insertion hole 43B formed through the convex portion 43 is open. A head 45A of the bolt 45 and the nut 47 screwed onto the bolt 45 which will be described later are respectively disposed in the recesses 42. The recesses 42 are formed to be upwardly spread in the long side direction so that tools can be fitted with the bolt head 45A and the nut 47 from above.

The base body 31 is hollow as illustrated in FIGS. 1 to 3. Furthermore, the base body 31 is downwardly open in the first base 30A placed in abutment on the top surface of the furniture F. The base body 31 has a plurality of ribs R1 extending in parallel to the short side direction in the inside thereof and two ribs R2 extending in parallel to the long side direction in the inside thereof so that the ribs R1 and the ribs R2 intersect with each other.

The rotating shaft member includes the bolt 45 inserted from one of the second insertion holes 43B of the base body 31 and the nut 47 screwed onto the shaft part 45B of the bolt 45, as illustrated in FIGS. 2 to 4. Central axes of the respective bolts 45 serve as rotation axes of the damper 10 in the bases 30A and 30B.

The bush 35 is substantially cylindrical in shape as illustrated in FIG. 3. The bush 35 is an elastic body. The bush 35 has a length that is slightly smaller than a distance between the inner wall surfaces 43A of the paired convex portions 43 provided in the base body 31. The bush 35 is formed with a concave portion 35A going around a central part of the outer peripheral surface thereof. The concave portion 35A has an outer diameter that substantially equals an inner diameter of the through hole ISA formed through the joint 15 of the damper 10. The bush 35 has portions rising radially outward from both ends of the concave portion 35A which portions have outer diameters larger than the inner diameter of the through hole 15A of the joint 15. Furthermore, both ends of the cylindrical shape of the bush 35 have respective outer peripheral surfaces 35B the diameters of which are outwardly reduced. As a result, the bush 35 is inserted into the through hole 15A of the joint 15 of the damper 10 while being elastically deformed. The concave portion 35A is then fitted into the through hole 15A so that the bush 35 is attached to the joint 15 of the damper 10.

The central part of the bush 35 has an inner diameter slightly larger than an outer diameter of the shaft part 45B of the bolt 45. Both ends of the bush 35 have inner peripheral surfaces 35C the diameters of which are outwardly enlarged. Accordingly, the bush 35 is rotatable about the shaft part 45B of the bolt 45. Furthermore, the bush 35 is inclinable with respect to the shaft part 45B of the bolt 45 to the extent that the inner peripheral surfaces 35C of both ends thereof having enlarged diameters abut against an outer peripheral surface of the shaft part 45B of the bolt 45. In other words, the damper 10 with the bush 35 attached to the joint 15 is rotatable about the shaft part 45B of the bolt 45 and swingable in a direction intersecting the rotation direction. More specifically, the damper 10 is swung due to the dimensional allowance and enlarged diameters of the inner peripheral surfaces 35C. Furthermore, by the elastic deformation of the bush 35, the damper 10 can be swung more largely in the direction intersecting the rotation direction.

The slip preventing part 37 has an outer shape which is similar to and slightly larger than the outer shape of the base body 31 (a rectangular shape), as illustrated in FIGS. 1 to 6. The slip preventing part 37 is made of rubber. In the first base 30A placed in abutment on the top surface of the furniture F, the slip preventing part 37 is fitted in a lower opening of the base body 31. Furthermore, the slip preventing part 37 is substantially flat in shape. In more detail, in the slip preventing part 37, a surface which abuts against the top surface of the furniture F or the ceiling C is flat, and an oppositely directed surface (the surface opposed to the base body 31) is formed with a fitting groove according to an outer peripheral wall of the base body 31 and the ribs R1 and R2 (refer to FIG. 3). The slip preventing part 37 is detachably attached to the base body 31 by an elastic force thereof.

The following will describe a step of assembling the damper 10 with the bases 30A and 30B.

First, the bushes 35 are respectively fitted into the through holes 15A formed through the two joints 15 provided at both ends of the damper 10 thereby to be attached to the joints 15 of the damper 10.

Next, one of the joints 15 of the damper 10 attached with the bush 35 is inserted between the paired convex portions 43 formed on the base body 31. The shaft part 45B of the bolt 45 is then inserted through the second insertion holes 43B of the base body 31 and the bush 35, and the nut 47 is screwed onto the shaft part 45B of the bolt 45. The base body 31 is thus coupled to one of the joints 15 of the damper 10. The other joint 15 of the damper 10 is also coupled to the other base body 31 in the similar manner. In this state, as illustrated in FIG. 2, the heads 45A of the bolts 45 and the nuts 47 (both ends of the rotating shaft members) are respectively exposed in the recesses 42 of the base bodies 31 at positions symmetrical with respect to a central axis of the damper 10.

Then, the slip preventing parts 37 are respectively fitted with the base bodies 31 coupled to both ends of the damper 10, so that the step of assembling the damper 10 with the bases 30A and 30B is finished.

In the damper 10 and the bases 30A and 30B thus assembled, the bushes 35 are respectively rotatable relative to the shaft parts 45B of the bolts 45. Accordingly, both ends of the damper 10 are respectively coupled to the bases 30A and 30B so as to be rotatable about the rotation axes. In other words, the bases 30A and 30B are coupled to the bottom 11B of the cylinder 11 and the distal end 13A of the rod 13, respectively. Furthermore, both ends of the bush 35 have the inner peripheral surfaces 35C the diameters of which are outwardly enlarged. Accordingly, the bush 35 is inclinable relative to the rotation axis to the extent that the inner peripheral surfaces 35C of both ends thereof having enlarged diameters abut against the outer peripheral surface of the shaft part 45B of the bolt 45. More specifically, the bush 35 is swung due to the dimensional allowance and enlarged diameters of the inner peripheral surfaces 35C. Furthermore, the bush 35 is an elastic body and by the elastic deformation thereof, the damper 10 can be swung more largely in a direction intersecting the rotation direction. Thus, the damper 10 coupled to the bases 30A and 30B is swingable in the direction intersecting the rotation direction.

The fall preventing part 50 is formed by bending a flat band-shaped metal as illustrated in FIGS. 1, 4, and 5. The fall preventing part 50 has a constant width that is slightly smaller than that of the groove 41 formed in the base body 31. In other words, the width of the fall preventing part 50 is slightly smaller than a length of the slit-like locked hole 49 formed in the base body 31. Furthermore, the fall preventing part 50 has a coupling part 51 and a drooping part 53. The coupling part 51 has a locking part 51A formed by bending one of ends thereof at a right angle. The drooping part 53 is continuous to the other end of the coupling part 51 and perpendicular to the coupling part 51 and extends in the same direction as the locking part 51A. The drooping part 53 of the fall preventing part 50 has a length set so as not to come out from between the wall surface W and the rear surface of the furniture F when the overturn preventing device falls in such a direction that an upper side thereof departs from the wall surface W, as described later. For example, the drooping part 53 has a length of not less than 100 mm below the slip preventing part 37.

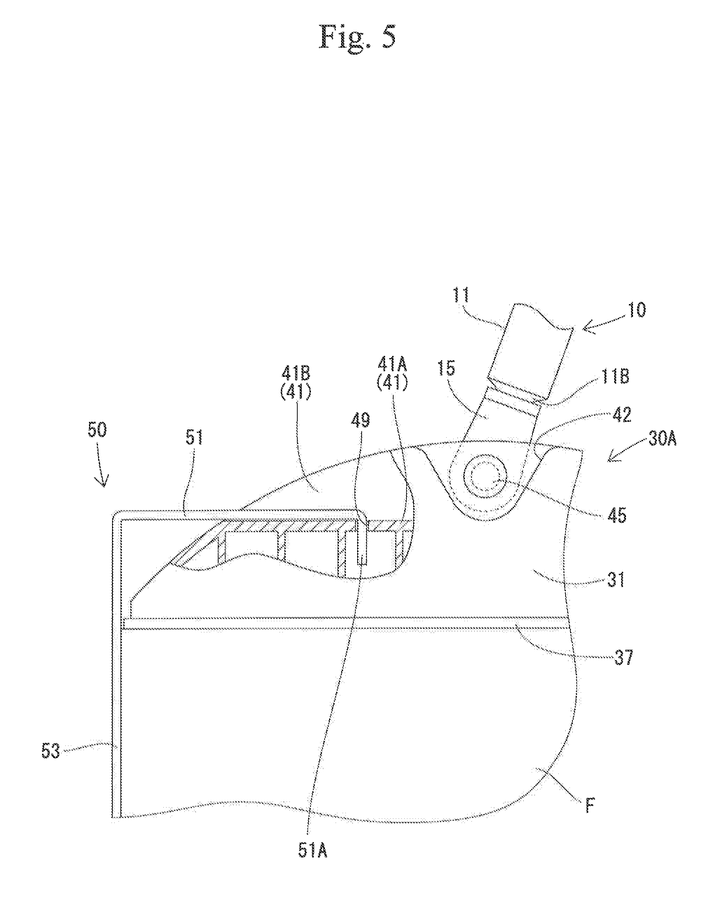

The fall preventing part 50 is attached to the first base 30A placed in abutment on the top surface of the furniture F as illustrated in FIGS. 1 and 5. In more detail, the locking part 51A of the coupling part 51 is inserted and locked in the locked hole 43 of the base body 31 of the first base 30A placed in abutment on the top surface of the furniture F, which locked hole 49 is located at the wall surface W side. Thus, the fall preventing part 50 can be easily attached to the first base 30A in this overturn preventing device. Furthermore, the fall preventing part 50 can be detached from the first base 30A during the packaging of the overturn preventing device or in other cases so that the overturn preventing device is prevented from bulking.

In a state of being attached to the base body 31 of the first base 30A, the coupling part 51 of the fall preventing part 50 extends along the groove 41 formed in the base body 31 and the other end of the coupling part 51 is located outside an outer edge of the first base 30A (an outer edge of the slip preventing part 37 of the first base 30A). The drooping part 53 droops from the other end of the coupling part 51 and extends downward slightly outside the outer edge of the slip preventing part 37 of the first base 30A. The fall preventing part 50 is disposed between the wall surface W and the rear surface of the furniture F below the first base 30A.

The angle regulator 70 is detachably attached to the first base 30A placed in abutment on the top surface of the furniture F as illustrated in FIGS. 1, 2, and 6. As a result, the angle regulator 70 can be detached from the first base 30A during the packaging of the overturn preventing device or in other cases so that the overturn preventing device is prevented from bulking. In a state of being attached to the first base 30A, the angle regulator 70 has a regulating part 71 which extends substantially vertically, and a support part 73 which is provided to be continuous from a lower part of the regulating part 71 and prevents the regulating part 71 from being inclined. The regulating part 71 is a flat plate and is substantially rectangular in shape. When the angle regulator 70 is attached to the first base 30A placed in abutment on the top surface of the furniture F, one end of the regulating part 71 serves as a receiving part 71A located at an upper end, and the other end is located at a lower end and serves as the insertion part 71B which is inserted into the locked hole 49 of the base body 31 located at the side away from the wall surface W.

The regulating part 71 causes the cylinder 11 of the damper 10 to abut against the receiving part 71A thereby regulating the damper 10 so as not to fall in excess of the inclined state. An inclination angle of the damper 10 preferably ranges from 15° to 25° relative to the vertical direction. The receiving part 71A is upwardly open and curved so as to be downwardly recessed at a central part thereof so that one third of the outer periphery of the cylinder 11 abuts thereagainst. Thus, since the cylinder 11 is not held tightly by the receiving part 71A, the movement, of the damper 10 is not restrained when the furniture F is tilted or shaken by shaking of earthquake or the like. In other words, in this overturn preventing device, the damper 10 is rotatable about the rotation axes relative to the bases 30A and 30B and swingable in the direction intersecting the rotation direction when the furniture F is shaken or tilted by shaking of earthquake or the like.

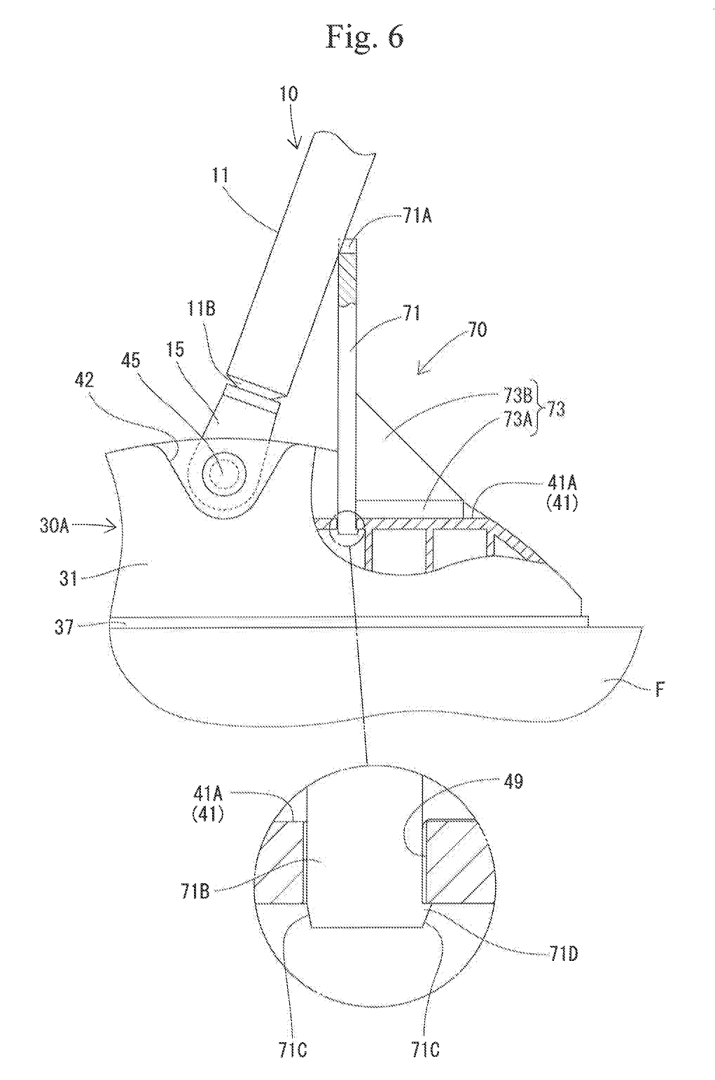

The insertion part 71B has inclined surfaces 71C respectively formed by cutting out both side corners of the short side in the long side direction so as to become thinner toward a distal end thereof, as illustrated in FIG. 6. The inclined surfaces 71C allow the insertion part 71B to be easily inserted into the locked hole 49 of the base body 31. The insertion part 71B also has a protrusion 71D protruding from one of sides of the distal end in the short side direction. The angle regulator 70 is detachable from the first base 30A. However, when a force acts on the angle regulator 70 in such a direction that the insertion part 71B is accidentally pulled out of the locked hole 49 of the base body 31, the protrusion 71D is caught by the locked hole 49, whereby the insertion part 71B is hard to pull out of the locked hole 49.

The support part 73 includes a first support part 73A and a second support part 73B. The first support part 73A has the same width as the regulating part 71 and is a fiat plate extending in a direction perpendicular to the regulating part 71. The first support part 73A abuts against the bottom 41A of the groove 41 formed in the base body 31 when the insertion part 71B of the regulating part 71 is inserted into the locked hole 49 of the base body 31 of the first base 30A. The second support part 73B is a flat plate which has an isosceles right triangle shape and is coupled to a corner between the first support part 73A and the regulating part 71. In more detail, the second support part 73B has two sides having an equal length which are respectively coupled to a side surface of the first support part 73A and a side surface of the regulating part 71, thereby supporting the regulating part 71 so that the first support part 73A and the regulating part 71 are perpendicular to each other.

The following will describe a manner of mounting the overturn preventing device between the top surface of the furniture F installed on the floor with the rear surface thereof being opposed to the wall surface W, and the ceiling C.

First, the locking part 51A of the fall preventing part 50 is inserted into one of the locked holes 49 formed in the base body 31 of the first base 30A of the overturn preventing device, whereby the fall preventing part 50 is attached to the first base 30A. The insertion part 71B of the angle regulator 70 is inserted into the other locked hole 49 formed in the base body 31 of the first base 30A whereby the angle regulator 70 is attached to the first base 30A.

Next, the first base 30A attached with the fall preventing part 50 and the angle regulator 70 is placed with the slip preventing part 37 abutting against the top surface of the furniture F at the wall surface W side. In this case, the first base 30A is placed on the top surface of the furniture F in such a manner that the drooping part 53 of the fall preventing part 50 droops along the rear surface of the furniture F. In other words, the drooping part 53 of the fall preventing part 50 is disposed between the wall surface W and the rear surface of the furniture F. Furthermore, in the state where the first base 30A is placed on the top surface of the furniture F, the shaft part 45B (rotation axis) of the bolt 45 of the first base 30A extends in a direction perpendicular to a direction in which the furniture F is tilted by shaking of earthquake or the like. In other words, the first base 30A is placed on the top surface of the furniture F so that the direction in which the damper 10 is rotated about the rotation axis is parallel to the direction in which the furniture F is tilted.

Next, the damper 10 of the overturn preventing device is compressed. In this case, the damper 10 is compressed to such an extent that a space is provided between the second base 30B and the ceiling C. The damper 10 is then inclined so that the cylinder 11 of the damper 10 abuts against the receiving part 71A of the angle regulator 70. In this state, the damper 10 is inclined at an appropriate angle ranging from 15° to 25° relative to the vertical direction. The direction of the second base 30B is corrected so that the shaft part 45B (the rotation axis) of the bolt 45 of the second base 30B becomes parallel to the shaft part 45B (the rotation axis) or the bolt 45 of the first base 30A. When compression of the damper 10 is stopped in this state, the damper 10 is extended by the elastic force of the spring 18 inserted into the cylinder 11, with the result that the second base 30B abuts against the ceiling C (refer to FIGS. 1 and 2). In other words, the bases 30A and 30B abut against the top surface of the furniture F and the ceiling C, respectively. At this time, the spring 18 inserted in the cylinder 11 is slightly compressed. That is, the elastic force is generated in the extension direction of the damper 10 in the state where the overturn preventing device is mounted between the top surface of the furniture F and the ceiling C. Thus, the damper 10 can be mounted between the top surface of the furniture F installed on the installation surface and the ceiling C while the extension/contraction thereof makes a predetermined angle relative to the vertical direction. The angle regulator 70 may be detached from the first base 30A after completion of the mounting work.

As described above, the damper 10 of the overturn preventing device can be inclined at an appropriate inclination angle by placing the first base 30A attached with the angle regulator 70 on the top surface of the furniture F, and the overturn preventing device can be mounted appropriately between the top surface of the furniture F and the ceiling C just by causing the second base 30B to abut against the ceiling C while maintaining the inclination angle of the damper 10.

Furthermore, consider the case where the overturn preventing device falls in such a direction that the upper side thereof departs from the wall surface W before the second base 30B is caused to abut against the ceiling C during the work of mounting the overturn preventing device between the top surface of the furniture F and the ceiling C, that is, when the first base 30A is placed in abutment on the top surface of the furniture F and the drooping part 53 of the fall preventing part 50 is disposed between the wall surface W and the rear surface of the furniture F. In this case, due to the force to tilt the overturn preventing device, the wall surface W side of the first base 30A abutting against the top surface of the furniture F is caused to float. Thereupon, the drooping part 53 of the fall preventing part 50 attached to the first base 30A is caught on the wall surface W. As a result, the overturn preventing device can be prevented from falling to the front surface side of the furniture F.

Next, the operation of the overturn preventing device will be described.

In the overturn preventing device mounted between top surface of the furniture F and the ceiling C, when the furniture F is tilted frontward by shaking of earthquake or the like, the first base 30A comes close to the second base 30B (not illustrated). As a result, the damper 10 is further contracted from a state where the overturn preventing device is mounted between the top surface of the furniture F and the ceiling C, with the result that the spring 18 is compressed whereby an elastic force of the damper 10 in the extension direction becomes larger (not illustrated). In other words, the elastic force of the damper 10 becomes larger with increase in a contraction dimension of the damper 10. Consequently, since the elastic force of the damper 10 is increased as the shaking of earthquake or the like becomes larger and the furniture F is tilted frontward to a larger extent, the furniture F can reliably be prevented from overturn.

Furthermore, in this overturn preventing device, as illustrated in FIG. 1, the damper 10 is mounted so that the axis line of the damper 10 extending from the ceiling C side to the top surface side of the furniture F is downwardly inclined and so that the axis line of the damper 10 extends in parallel to the direction in which the furniture F is tilted by shaking of earthquake or the like in a planar view as viewed from above. Accordingly, the elastic force of the spring 18 of the damper 10 can be caused to effectively act against the tilt of the furniture F, with the result that this overturn preventing device can prevent the furniture F from overturn.

Furthermore, both ends of the damper 10 are respectively coupled via the bushes 35 to the bases 30A and 30B in the overturn preventing device. Each bush 35 is an elastic body and has both ends further having the inner peripheral surface 35C the diameters of which are outwardly enlarged. Consequently, being swung due to the dimensional allowance and the enlarged diameter of the inner peripheral surfaces 35C, each bush 35 can be inclined with respect to the rotation axis to the extent that the inner peripheral surfaces 35C of both ends thereof having enlarged diameters abut against the outer peripheral surface of the shaft part 45B of the bolt 45. As a result, the damper 10 coupled to the bases 30A and 30B can be swung in the direction intersecting with the rotation direction. In other words, the bases 30A and 30B of the overturn preventing device are swung in the direction intersecting the rotation direction relative to the rod 13.

Thus, characteristics of the spring 18 can easily be changed to desirable ones by adjusting the cross-sectional area or material of the metal wire forming the spring 18, an outer diameter of the helical shape of the spring 18, a dimension between parts adjacent to each other in the extension/contraction direction of the helically formed metal wire, or the like. In other words, the characteristics of the spring 18 can easily be optimized according to the size, the weight or the like of the furniture F on which the overturn preventing device is to be mounted. Furthermore, since the overturn preventing device does not need to use any hydraulic fluid and any nitrogen gas, the facilities to manufacture the overturn preventing devices can be simplified.

Furthermore, the damper 10 is rotated about the rotation axes when the furniture F is tilted by shaking of earthquake or the like in the direction in parallel to the rotation direction of the bases 30A and 30B relative to the bottom 11B of the cylinder 11 and the distal end 13A of the rod 13. As a result, even when the furniture F is tilted by shaking of earthquake or the like, the bases 30A and 30B are respectively maintained in abutment against the top surface of the furniture F and the ceiling C, whereby the furniture F can be prevented from overturn.

Accordingly, the overturn preventing device of the first embodiment can successfully prevent the furniture F from overturn with a simple structure.

Furthermore, the bases 30A and 30B of the overturn preventing device are swung in the direction intersecting the rotation direction relative to the rod 13. As a result, even when the furniture F is shaken by shaking of earthquake or the like in the direction intersecting the rotation direction of the bases 30A and 30B relative to the bottom 11B of the cylinder 11 and the distal end 13A of the rod 13, the bases 30A and 30B can respectively be maintained in abutment against the top surface of the furniture F and the ceiling C since the bases 30A and 30B are swung in the direction intersecting the rotation direction. When the furniture F is tilted in the direction parallel to the rotation direction of the bases 30A and 30B, the damper 10 is rotated about the rotation axes, so that the tilt of the furniture F is suppressed by the elastic force generated by the damper 10 with the result that the furniture F can be prevented from overturn. In other words, the bases 30A and 30B are respectively maintained in abutment against the top surface of the furniture F and the ceiling C against earthquake or the like with multidirectional shaking, with the result that the furniture F can be prevented from overturn.

### Second Embodiment

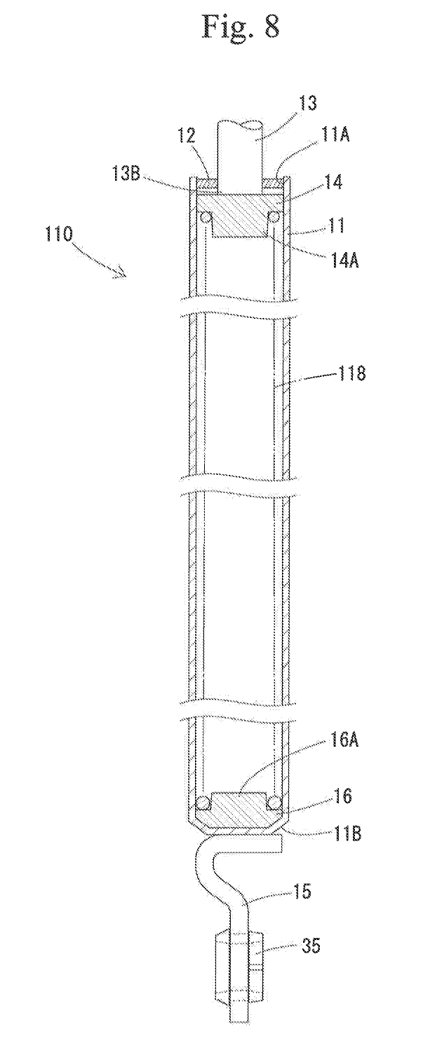

The overturn preventing device of a second embodiment differs from that of the first embodiment in the form of the spring 118, as illustrated in FIG. 8. Other construction is same as that of the first embodiment. Identical or similar parts are labeled by the same reference symbols as those in the first embodiment, and the detailed description of these parts will be eliminated. Furthermore, the manner of mounting the overturn preventing device between the top surface of the furniture and the ceiling is similar to that in the first embodiment.

A cross-sectional area of the metal wire is gradually increased from one end of the spring 118 inserted into the cylinder 11 of the damper 110 toward the other end of the spring 118 with respect to the extension/contraction direction. Furthermore, the outer diameter of the helical shape of the spring 118 is constant from the one end to the other end thereof, and the dimension between parts adjacent to each other in the extension/contraction direction of the helically formed metal wire is also constant. In other words, the spring constant of the spring 118 of this overturn preventing device is gradually increased from the one end side to the other end side. In other words, the spring 118 has a plurality of different spring constants with respect to the extension/contraction direction. Furthermore, the outer diameter of the helical shape of the spring 118 is slightly smaller than an inner diameter of the cylinder 11.

One of two ends of the spring 118 abuts against one end surface of the piston 14. The first guide 14A of the piston 14 is inserted into the one end part of the one end of the spring 118. The other end of the spring 118 abuts against one end surface of the abutting member 16. The second guide 16A of the abutting member 16 is inserted into the other end part of the spring 118.

In the damper 110 thus formed, when the rod 13 is pushed into the cylinder 11 so that the spring 118 is compressed, an elastic force is generated in the direction such that the rod 13 extends from the cylinder 11. The elastic force becomes larger as the dimension of a part of the rod 13 pushed into the cylinder 11 is increased. Furthermore, since the spring 118 has a larger spring constant at the other end side than at the one end side, a dimension of the one end side compressed is larger than a dimension of the other end side compressed. In other words, when the overturn preventing device is mounted between the top surface of the furniture F and the ceiling C, the one end side of the spring 118 having a smaller spring constant can be compressed by a smaller force than the other end side of the spring 118, with the result that the overturn preventing device can easily be mounted between the top surface of the furniture F and the ceiling C. Furthermore, the furniture F is tilted frontward by shaking of earthquake or the like with the overturn preventing device being mounted between the top surface of the furniture F and the ceiling C, the other end side of the spring 118 having the larger spring constant is also compressed more with the result that a larger elastic force is generated. As a result, the overturn preventing device can reliably suppress tilt of the furniture F by the shaking of earthquake or the like and can accordingly prevent the furniture F from overturn.

Thus, in this overturn preventing device, too, characteristics of the spring 118 can easily be changed to desirable ones by adjusting the cross-sectional area or material of the metal wire forming the spring 118, an outer diameter of the helical shape of the spring 118, a dimension between parts adjacent to each other in the extension/contraction direction of the helically formed metal wire, or the like. In other words, the characteristics of the spring 118 can easily be optimized according to the size, the weight or the like of the furniture F on which the overturn preventing device is to be mounted. Furthermore, since the overturn preventing device does not need to use any hydraulic fluid and any nitrogen gas, the facilities to manufacture the overturn preventing devices can be simplified.

Accordingly, the overturn preventing device of the second embodiment can successfully prevent the furniture F from overturn with a simple structure.

Furthermore, the spring 118 of the overturn preventing device has a plurality of different spring constants with respect to the extension/contraction direction. Accordingly, the spring constant can be changed between the case where the overturn preventing device is mounted between the top surface of the furniture F and the ceiling C and the case where the furniture F is tilted by shaking of earthquake or the like after the overturn preventing device has been mounted between the top surface of the furniture F and the ceiling C. As a result, in the case where the overturn preventing device is to be mounted between the top surface of the furniture F and the ceiling C, the spring constant of the spring 118 is set to be smaller. Consequently, the overturn preventing device can easily be mounted between the top surface of the furniture F and the ceiling C. Furthermore, in the state where the overturn preventing device has been mounted between the top surface of the furniture and the ceiling C, the spring constant of the spring 118 is set to be larger than that in the case where the overturn preventing device is to be mounted between the top surface of the furniture f and the ceiling C, with the result that the tilt of the furniture F by shaking of earthquake or the like can reliably be suppressed.

### Third Embodiment

The overturn preventing device of a third embodiment differs from that of the first and second embodiments in that a plurality of spring members 218A and 218B is arranged in series with each other with a buffer member 17 being interposed therebetween. Other construction is same as those of the first and second embodiments in the other construction. Identical or similar parts are labeled by the same reference symbols as those in the first and second embodiments, and the detailed description of these parts will be eliminated. Furthermore, the manner of mounting the overturn preventing device between the top surface of the furniture and the ceiling is similar to those in the first and second embodiment.

A plurality of spring members 218A and 218B serving as the spring 218 is inserted into the cylinder 11 of the damper 210 in series with each other. The metal wire of the spring member 218A has a smaller cross-sectional area than the metal wire of the spring member 218B. Furthermore, the spring members 218A and 218B are made of the same material. Each of the spring members 218A and 218B has a substantially constant outer diameter from one end to the other end thereof, and has a substantially constant dimension between parts adjacent to each other in the extension/contraction direction of the helically formed metal wire. In other words, the spring 218 includes the serially arranged spring members 218A and 218B having different spring constants. The spring member 218A has a smaller spring constant than the spring member 218B. The spring members 218A and 218B have the respective outer diameters slightly smaller than the inner diameter of the cylinder 11. The spring member 218A has two ends one of which abuts against one end surface of the piston 14. The first guide 14A of the piston 14 is inserted into the one end part of the spring member 218A. Furthermore, the other end of the spring member 218B abuts against one end surface of the abutting member 16. The second guide 16A of the abutting member 16 is inserted into the other end part of the spring member 218B.

A buffer member 17 is provided between the spring members 218A and 218B. In more detail, the buffer member 17 is slidably inserted into the cylinder 11. The buffer member 17 is provided with a third guide 17A formed to protrude from a central part of one end surface thereof and a fourth guide 17B formed to protrude from a central part of the other end surface thereof. The one end surface of the buffer member 17 abuts against the other end of the spring member 218A. The third guide 17A is inserted into the other end part of the spring member 218A. The other end surface of the buffer member 17 abuts against the one end of the spring member 218B. The fourth guide 17B is inserted into the one end part of the spring member 218B.

In the damper 210 thus formed, when the rod 13 is pushed into the cylinder 11 so that the spring 118 is compressed, an elastic force is generated in the direction such that the rod 13 extends from the cylinder 11. The elastic force becomes larger as the dimension of a part of the rod 13 pushed into the cylinder 11 is increased. Furthermore, the spring member 218A has a smaller spring constant than the spring member 218B. As a result, when the rod 13 is pushed into the cylinder 11, the spring member 218A is compressed by a larger amount than the spring member 218B. And when the rod 13 is further pushed into the cylinder 11, the parts adjacent in extension/contraction direction of the helically formed metal wire of the spring member 218A are brought into close contact with each other prior to those of the spring member 218B. In other words, the overturn preventing device can easily be mounted between the top surface of the furniture F and the ceiling C since the spring member 218A having the smaller spring constant can be compressed by a smaller force as compared with the spring member 218B. Furthermore, when the furniture F is tilted frontward by shaking of earthquake or the like with the overturn preventing device being mounted between the top surface of the furniture F arid the ceiling C, the spring member 218B having the larger spring constant is also compressed more with the result that a larger elastic force is generated. As a result, the overturn preventing device can reliably suppress tilt of the furniture F by the shaking of earthquake or the like and can accordingly prevent the furniture from overturn.

Thus, in this overturn preventing device, too, characteristics of the spring 218 can easily be changed to desirable ones by adjusting the cross-sectional area or material of the metal wire forming the spring 218, an outer diameter of the helical shape of the spring 218, a dimension between parts adjacent to each other in the extension/contraction direction of the helically formed metal wire, or the like. In other words, the characteristics of the spring 218 can easily be optimized according to the size, the weight or the like of the furniture F on which the overturn preventing device is to be mounted. Furthermore, since the overturn preventing device does not need to use any hydraulic fluid and any nitrogen gas, the facilities to manufacture the overturn preventing devices can be simplified.

Accordingly, the overturn preventing device of the third embodiment can successfully prevent the furniture F from overturn with a simple structure.

Furthermore, a plurality of spring members 218A and 218B having different spring constants are serially arranged in this overturn preventing device. Accordingly, the outer diameter of the cylinder 11 housing the spring 218 can be rendered smaller. As a result, the appearance of the overturn preventing device can be improved.

### Fourth Embodiment

The overturn preventing device of a fourth embodiment differs from that of the first to third embodiments in that a plurality of spring members 318A and 318B is arranged in parallel, in the form of the piston 314 and the form of the abutting member 316. Other construction is same as those of the first to third embodiments. Identical or similar parts are labeled by the same reference symbols as those in the first to third embodiments, and the detailed description of these parts will be eliminated. Furthermore, the manner of mounting the overturn preventing device between the top surface of the furniture F and the ceiling C is similar to those in the first to third embodiments.

A plurality of spring members 318A and 318B serving as the spring 318 is inserted in the cylinder 11 of the damper 310 in parallel with each other. In more detail, the spring member 318A has a smaller cross-sectional area of metal wire than the spring member 318B. Furthermore, the spring members 318A and 318B are made of the same material. Each of the spring members 318A and 318B has a constant outer diameter from one end to the other end thereof. The spring member 318A has an inner diameter that is larger than the outer diameter of the spring member 318B. The spring members 318A and 318B have the substantially same dimensions between parts adjacent to each other in the extension/contraction direction of the helically formed metal wire. In other words, the spring member 318A has a smaller spring constant than the spring member 318B. The outer diameter of the spring member 318A is slightly smaller than the inner diameter of the cylinder 11. The dimension of the spring member 318A from one end to the other end thereof is larger than that of the spring member 318B. The spring member 318A and 318B thus formed are arranged so that the spring member 318B is disposed inside the helical shape of the spring member 318A. In other words, the spring 318 includes the spring members 318A and 318B which have different spring constants and are arranged in parallel with each other.

The piston 314 is slidably inserted into the cylinder 11. The piston 314 is provided with a first guide 314A formed to protrude from a central part of one end surface thereof. The piston 314 is also provided with a fifth guide 314B formed to protrude from a central part of the distal end surface of the first guide 314A.

The abutting member 316 is provided in the bottom 11B which is a closed end of the cylinder 11. The abutting member 316 is provided with the second guide 316A formed to protrude from a central part of one end surface thereof. The abutting member 316 is also provided with a sixth guide 316B formed to protrude from a central part of a distal end surface of the second guide 316A. The abutting member 316 has the other end brought into close contact with the bottom 11B of the cylinder 11.

The spring member 318A has two ends one of which abuts against one end surface of the piston 314. The first guide 314A and the fifth guide 314B of the piston 314 are inserted into the one end part of the spring member 318A. The other end of the spring member 318A abuts against one end surface of the abutting member 316. The second guide 316A and the sixth guide 316B of the abutting member 316 are inserted into the other end part of the spring member 318A.

One end of the spring member 318B does not abut against the distal end surface of the first guide 314A of the piston 314. The fifth guide 314B of the piston 314 is inserted into the one end part of the spring member 318B. The other end of the spring member 313B abuts against the distal end surface of the second guide 316A. The sixth guide 316B of the abutting member 316 is inserted into the other end part of the spring member 318B.

In the damper 310 thus formed, when the rod 13 is pushed into the cylinder 11 of the damper 310 thus formed, only the spring member 318A is first compressed since the one end of the spring member 318B does not abut against the distal end surface of the first guide 314A of the piston 314. When the rod 13 is further pushed into the cylinder 11, the distal end surface of the first guide 314A of the piston 314 abuts against the one end of the spring member 3183 with the result, that the spring 318B is also compressed. Thus, an elastic force is generated in the damper 310 in the direction of extension of the rod 13 from the cylinder 11. The elastic force generated when the spring members 318A and 318B are compressed is larger than the elastic force generated when only the spring member 318A is compressed. The elastic force is increased with increase in the dimension of the part of the rod 13 pushed into the cylinder 11. In other words, the overturn preventing device can easily be mounted between the top surface of the furniture F and the ceiling C since the spring member 318A is first compressed by a small force. Furthermore, when the furniture F is titled frontward by shaking of earthquake or the like with the overturn preventing device being mounted between the top surface of the furniture F and the ceiling C, the spring member 318B is also compressed in addition to the spring member 318A with the result that a larger elastic force is generated. As a result, the overturn preventing device can reliably suppress tilt of the furniture F by the shaking of earthquake or the like and can accordingly prevent the furniture from overturn.

Thus, in this overturn preventing device, too, characteristics of the spring 318 can easily be changed to desirable ones by adjusting the cross-sectional area or material of the metal wire forming the spring 318, an outer diameter of the helical shape of the spring 318, a dimension between parts adjacent to each other in the extension/contraction direction of the helically formed metal wire, or the like. In other words, the characteristics of the spring 318 can easily be optimized according to the size, the weight or the like of the furniture F on which the overturn preventing device is to be mounted. Furthermore, since the overturn preventing device does not need to use any hydraulic fluid and any nitrogen gas, the facilities to manufacture the overturn preventing devices can be simplified.

Accordingly, the overturn preventing device of the fourth embodiment can successfully prevent the furniture F from overturn with a simple structure.

Furthermore, the spring 318 of the overturn preventing device includes the spring members 318A and 318B which have different spring constants and are arranged in parallel with each other. As a result, the length of the cylinder 11 housing the spring 318 can be rendered smaller. Accordingly, the overall length of the overturn preventing device can be rendered smaller, with the result that the overturn preventing device can be mounted even when the space between the top surface of the furniture F and the ceiling C for mounting the overturn preventing device is small.

The present invention should not be limited to the first to fourth embodiments described above with reference to the drawings, but the technical scope of the invention encompasses the following embodiments, for example.

(1) Although the overturn preventing device is mounted on the furniture in the first embodiment, the overturn preventing device may be mounted on an article such as a bookshelf or a refrigerator which has a possibility of overturn by shaking of earthquake or the like.
(2) Although the overturn preventing device is mounted on the furniture installed on the floor with its rear surface being opposed to the wall surface in the first embodiment, the overturn preventing device may be mounted on the furniture or the like installed on the floor without being adjacent to the wall surface.
(3) In the first embodiment, the bases respectively have the bushes through which the rotation shaft members are inserted, so that the damper is allowed to swing in the direction intersecting the rotation direction of the damper. However, another structure may be provided to allow the damper to swing in the direction intersecting the rotation direction.
(4) Although both ends of each bush have the inner peripheral surfaces diameters of which are outwardly enlarged in the first embodiment, the diameters may not be outwardly enlarged. In this case, the bushes may be elastic bodies so that the elastic deformation of the bushes should allow the damper to swing in the direction intersecting the rotation direction.
(5) Although the bushes are elastic bodies in the first embodiment, the bushes may not be elastic bodies.
(6) Forms of the bases should not be limited to those in the first embodiment.
(7) Although the overturn preventing device includes the fall preventing part in the first embodiment, the overturn preventing device may not include the fall preventing part. Furthermore, the fall preventing part may be formed integrally with the first base.
(8) Although the overturn preventing device includes the angle regulator in the first embodiment, the overturn preventing device may not include the angle regulator. Furthermore, although the angle regulator is detachably attached to the first base in the first embodiment, the angle regulator may be formed integrally with the first base or the cylinder of the damper.
(9) Although the spring is made of the metal wire in each of the first to fourth embodiments, the spring may not be made of the metal wire.
(10) Although the cross-section property of the metal wire is changed from one end to the other end of the spring in the second embodiment, the cross-sectional area of the metal wire may be constant from the one end to the other end of the spring while refining is changed between the one end side and the other end side. Alternatively, the cross-sectional area of the metal wire may be constant from the one end to the other end of the spring while the dimension between adjacent parts of the helically formed metal wire is changed between the one end side and the other end side.
(11) Although two springs having different spring constants are used in each of the third and fourth embodiments, three or more springs having different spring constants may be used. Furthermore, two or more springs each having different spring constants at one end side and at the other end side, may be used.
(12) Although two springs made of the same material are used in each of the third and fourth embodiments, the springs made of different materials from each other may be used.

### EXPLANATION OF REFERENCE SYMBOLS

C . . . ceiling; F . . . furniture (article) ; 10, 110, 210, 310 . . . damper; 11 . . . cylinder; 11A . . . opening (open end) ; 11B . . . bottom (closed end); 13 . . . rod; 13A . . . distal end;, 18, 118, 218, 318 . . . spring; 30A, 30B . . . bases (30A . . . first base, 30B . . . second base); and 218A, 218B, 318A, 318B . . . spring member.

1. An overturn preventing device comprising:
a damper having:
a cylinder to be mounted between a top surface of an article installed on an installation surface and a ceiling so that a direction of extension/contraction makes a predetermined angle relative to a vertical direction, the cylinder having two ends one of which is open to be formed into an open end and the other of which is closed to be formed into a closed end, the cylinder being bottomed;
a rod inserted into the cylinder and having a distal end protruding from the open end of the cylinder; and
a spring provided between a proximal end of the rod and the closed end of the cylinder; and
a pair of bases rotatably coupled to the closed end of the cylinder and the distal end of the rod, respectively, the bases being configured to abut against the top surface of the article and the ceiling, respectively.

2. The overturn preventing device according to claim 1, wherein the spring has a plurality of different spring constants with respect to the direction of extension/contraction.

3. The overturn preventing device according to claim 1, wherein the spring includes a plurality of spring members having different spring constants and arranged in series with each other.

4. The overturn preventing device according to claim 1, wherein the spring includes a plurality of spring members having different spring constants and arranged in parallel with each other.

5. The overturn preventing device according to claim 1, wherein the paired bases are swung in a direction intersecting a rotation direction relative to the rod.

6. The overturn preventing device according to claim 2, wherein the spring includes a plurality of spring members having different spring constants and arranged in series with each other.

7. The overturn preventing device according to claim 6, wherein the spring includes a plurality of spring members having different spring constants and arranged in parallel with each other.

8. The overturn preventing device according to claim 7, wherein the paired bases are swung in a direction intersecting a rotation direction relative to the rod.
